(19) United States
(12) Patent Application Publication
(10) Pub. No.: US 2025/0242299 A1
(43) Pub. Date: Jul. 31, 2025

(54) MIXED LINKER MOF-BASED MEMBRANES FOR GAS SEPARATION

(71) Applicant: King Abdullah University of Science and Technology, Thuwal (SA)

(72) Inventors: Mohamed EDDAOUDI, Thuwal (SA); Sheng ZHOU, Thuwal (SA); Osama SHEKHAH, Thuwal (SA); Jiangtao JIA, Thuwal (SA)

(21) Appl. No.: 18/854,658

(22) PCT Filed: Apr. 7, 2023
(86) PCT No.: PCT/IB2023/053587

§ 371 Date: Oct. 7, 2024

Related U.S. Application Data
(60) Provisional application No. 63/328,401, filed on Apr. 7, 2022.

(51) Int. Cl. B01D 53/22; B01D 67/00; B01D 69/02; B01D 69/14; C10L 3/10

(52) U.S. Cl. CPC B01D 53/228; B01D 67/00793; B01D 69/02; B01D 69/148; C10L 3/101; B01D 2256/245; B01D 2257/102; B01D 2257/108; B01D 2257/504; B01D 2325/022

(57) ABSTRACT

In general, embodiments of the present disclosure describe mixed linker metal-organic framework (MOF) membrane composition, the MOF composition comprises a plurality of polynuclear metal clusters, wherein at least one of the polynuclear metal clusters includes a group IV metal or rare earth metal; and a plurality of polydentate linkers linking one or more polynuclear metal clusters; wherein the MOF has asymmetric pore aperture; wherein the composition is represented by the general formula: M-L1₍₁₀₀₋ₓ₎-L2ₓ including a metal (M) and linkers L1 and L2, wherein x is the molar percentage of L2 in membranes.

### CROSS-REFERENCE TO RELATED APPLICATION

This application claims benefit of U.S. Provisional Application No. 63/328,401 filed on Apr. 7, 2022. U.S. Provisional Application No. 63/328,401 is incorporated herein by reference. A claim of priority is made.

### BACKGROUND

Natural gas is an important low-carbon fuel for a clean-energy future. However, natural gas reservoirs are usually contaminated with nitrogen, which dilutes the heating value of natural gas and should be removed. The inertness of nitrogen and its similarities to methane in terms of kinetic size and polarizability pose particular challenges in the development of energy-efficient nitrogen-removing membranes-based technology.

Among current developments in natural gas upgrading technologies, CO₂ capture has been the main focus in academia. However, N₂ must also be effectively removed because it substantially decreases the heating value of the natural gas. Indeed, approximately 50% of the world's volume of natural gas reserves, known as sub-quality reservoirs, exceed the maximum 4% N₂ pipeline specification, necessitating the exploration of energy- and cost-efficient technologies capable of separating N₂ from CH₄.

### SUMMARY

In general, embodiments of the present disclosure describe mixed linker metal-organic framework (MOF) membrane composition, the MOF composition comprises a plurality of polynuclear metal clusters, wherein at least one of the polynuclear metal clusters includes a group IV metal or rare earth metal; and a plurality of polydentate linkers linking one or more polynuclear metal clusters; wherein the MOF has asymmetric pore aperture; wherein the composition is represented by the general formula: M-L1₍₁₀₀₋ₓ₎-L2ₓ including a metal (M) and linkers L1 and L2, wherein x is the molar percentage of L2 in membranes.

Embodiments of the present disclosure also describe a method of making a mixed linker metal-organic framework (MOF) membrane which comprises preparing a metal cluster solution and contacting the metal cluster with precalculated mass of at least two different linkers. This is followed by sonicating the cluster solution sufficient to form a homogeneous mixture. Optionally a support is immersed into the homogeneous mixture, after which current is applied to the mixture sufficient to form a crystalline mixed linker metal-organic framework (MOF) membrane with asymmetric pore aperture.

Embodiments of the present disclosure further describe a method for separating chemical species from a mixture of gases comprising contacting the mixed linker MOF membrane having asymmetric pore aperture with a mixture of gases comprising at least two chemical species and selectively permeating the at least one chemical species through the membrane, thereby separating the chemical species from the mixture, wherein the mixed linker MOF membrane comprises a plurality of polynuclear metal clusters and a plurality of polydentate linkers linking one or more polynuclear metal clusters and wherein at least one of the polynuclear metal clusters includes a group IV metal or a rare metal.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. Reference is made to illustrative embodiments that are depicted in the figures, in which:

FIGS. 1(a-c) illustrates the schematic illustrations of pore aperture editing and shape-mismatch-induced separation based on shape difference. FIG. 1a shows the molecular configurations of CH₄ and N₂, respectively. The tetrahedral CH₄ molecule shows a trefoil-shaped side-view profile, while the linear N₂ molecule shows a circular side-view profile. FIG. 1b is the illustration of the regular trefoil-shaped aperture of Zr-fum-fcu-MOF and the free diffusions of both CH₄ and N₂ molecules. FIG. 1c is the illustration of the irregular entrance of Zr-fum-mes-fcu-MOF created by subtle pore aperture editing. The tetrahedral CH₄ molecule is excluded due to the shape mismatch with the modified irregular entrance, while the linear N₂ molecule can still freely diffuse. (fum: fumarate; mes: mesaconate).

FIG. 2 is a flowchart illustrating the steps utilized in a method for preparation of mixed linker MOF membrane composition according to one or more embodiments of the present disclosure.

FIG. 3a and FIG. 3b are schematic illustrations of the design strategy to induce irregularity for CH₄ exclusion. FIG. 3a is a synthetic route for the growth of mixed-linker MOF membranes. FIG. 3b is the schematic illustration of the irregular aperture shape.

FIGS. 4(A-J) is a synthetic guide and characterization of pore aperture-edited Zr-fum₍₁₀₀₋ₓ₎-mesₓ-fcu-MOF membranes. FIG. 4A is a prediction of the required concentrations of ligands for continuous MOF membranes as functions of ligand pKa values using an electrochemical approach in an aqueous system. FIG. 4B shows the Required concentrations of fumaric acid and mesaconic acid as functions of targeted mes percentages for the preparation of Zr-fum₍₁₀₀₋ₓ₎-mesₓ-fcu-MOF membranes obtained by using an electrochemical approach. FIG. 4C shows the comparison of real mes percentages in resultant membranes with theoretical targets. FIG. 4(D-I) show the cross-sectional images of: Zr-fum₁₀₀-mes₀-fcu-MOF (FIG. 4D), Zr-fum₇₉-mes₂₁-fcu-MOF (FIG. 4E), Zr-fum₆₇-mes₃₃-fcu-MOF (FIG. 4F), Zr-fum₆₀-mes₄₀-fcu-MOF (FIG. 4G), Zr-fum₄₁-mes₅₉-fcu-MOF membrane (FIG. 4H), and Zr-fum₆₇-mes₃₃-fcu-MOF membrane (FIG. 4I) supported on stainless-steel nets modified by carbon nanotubes. FIG. 4J shows the 2D ¹³C-¹³C MAS solid-state NMR spectra. Polarization of ¹³C atoms was achieved through direct excitation and a mixing period of 200 ms. Proton-driven spin diffusion using phase-alternated recoupling irradiation schemes was used. The corresponding correlations among atoms from the two ligands are marked. (fum: fumarate; mes: mesaconate).

FIG. 5 is a flowchart illustrating the steps utilized in a method for separating chemical species from a mixture of gases, according to one or more embodiments of the present disclosure.

FIGS. 6(a-m) show the structures and XRD patterns of Zr-fum-mes-fcu MOF membranes. FIGS. 6(a-d) show the Unit-cell structure of Zr-fum-fcu-MOF (FIG. 6a), Zr-mes-fcu-MOF (FIG. 6b), Zr-fum₆₇-mes₃₃-fcu-MOF (FIG. 6c), and UiO-66 (FIG. 6d). The structures with “zigzag” linker geometry (fum or mes) exhibit tilted Zr clusters, while the structure with strictly straight linker (UiO-66) shows no tilt. FIGS. 6 (e-m) show the XRD patterns of: calculated structures (FIG. 6e), bare Anodisc (FIG. 6f), bare SSN (FIG. 6g), as-synthesized Zr-fum₁₀₀-mes₀-fcu-MOF membrane on Anodisc (FIG. 6h), as-synthesized Zr-fum₇₉-mes₂₁-fcu-MOF membrane on Anodisc (FIG. 6i), as-synthesized Zr-fum₆₇-mes₃₃-fcu-MOF membrane on Anodisc (FIG. 6j), as-synthesized Zr-fum₆₀-mes₄₀-fcu-MOF membrane on Anodisc (FIG. 6k), as-synthesized Zr-fum₄₁-mes₅₉-fcu-MOF membrane on Anodisc (FIG. 6l), and as-synthesized Zr-fum₆₇-mes₃₃-fcu-MOF membrane on SSN (FIG. 6m).

FIGS. 7(A-J) show the separation performances of Zr-fum₍₁₀₀₋ₓ₎mesₓ-fcu-MOF membranes and diffusion energy barriers. FIG. 7A shows the single-gas permeations of Zr-fum₍₁₀₀₋ₓ₎-mesₓ-fcu-MOF membranes. FIG. 7B shows the N₂/CH₄ mixed-gas separation performances of Zr-fum₍₁₀₀₋ₓ₎-mesₓ-fcu-MOF membranes. FIG. 7C is the schematic illustration of the pseudo-linear profile of ethylene and its permeation through the irregular aperture. FIG. 7D, FIG. 7F, and FIG. 7H shows the schematic illustrations of the diffusion of N₂ and CH₄ through the pore apertures of the simulated Zr-fum₁₀₀-mes₀-fcu-MOF (FIG. 7D), Zr-fum₆₇-mes₃₃-fcu-MOF (FIG. 7F), and Zr-fum₃₃-mes₆₇-fcu-MOF membranes (FIG. 7H). FIG. 7E, FIG. 7G, and FIG. 7I show the Minimum energy pathways for the diffusion of N₂ and CH₄ through Zr-fum₁₀₀-mes₀-fcu-MOF (FIG. 7E), Zr-fum₆₇-mes₃₃-fcu-MOF (FIG. 7G), and Zr-fum₃₃-mes₆₇-fcu-MOF membranes (FIG. 7I). FIG. 7J is a comparison of the simulated energy barriers for the diffusion barriers of N₂ and CH₄ throughout different MOF frameworks. (fum: fumarate; mes: mesaconate).

FIG. 8a and FIG. 8b show single-gas permeation behavior of Zr-fum-mes-fcu-MOF membranes. FIG. 8a shows the Ideal selectivities of different Zr-fum-mes-fcu-MOF membranes for different gas pairs. FIG. 8b shows the cut-off mitigation among different Zr-fum-mes-fcu-MOF membranes as a function of mes percentage.

FIG. 9a and FIG. 9b show the N₂/CH₄ mixed-gas separation behavior of Zr-fum₆₇-mes₃₃-fcu-MOF membranes with varied temperature. FIG. 9a shows the Change of permeances and separation factor with temperature increasing from 25° C. to 150° C. FIG. 9b shows the Arrhenius temperature dependence of N₂ and CH₄ permeances for the Zr-fum₆₇-mes₃₃-fcu-MOF membrane.

FIGS. 10(A-F) show the Comprehensive evaluations of N₂/CH₄ separation performance of Zr-fum₆₇-mes₃₃-fcu-MOF membranes under practical conditions. FIG. 10A shows the N₂/CH₄ separation performance comparison between Zr-fum₆₇-mes₃₃-fcu-MOF membranes and other previously reported membranes. The solid and dotted lines are eye guides for polymeric and zeolite membranes, respectively. FIG. 10B shows the High-pressure separation performance of Zr-fum₆₇-mes₃₃-fcu-MOF membranes. The inset box highlights the best-performing zeolite SSZ-13 membranes. FIG. 10C shows the N₂ flux comparison and N₂/CH₄ separation factor comparison between Zr-fum₆₇-mes₃₃-fcu-MOF membranes and other reported membranes. FIG. 10D shows the Long-term operational stability of Zr-fum₆₇-mes₃₃-fcu-MOF membranes. After Day 40, the feed pressure was fixed at 10 bar, and the permeate side was kept at atmospheric pressure without sweep gas. FIG. 10E shows the 35% CO₂/15% N₂/50% CH₄ ternary mixed-gas separation performance comparison between Zr-fum₆₇-mes₃₃-fcu-MOF membranes and other reported membranes. FIG. 10F shows the High-pressure separation performance of Zr-fum₆₇-mes₃₃-fcu-MOF membranes when applied to a 35% CO₂/15% N₂/50% CH₄ ternary mixed gas. (fum: fumarate; mes: mesaconate).

FIGS. 11(a-c) show the Stability of Zr-fum₆₇-mes₃₃-fcu-MOF membranes under harsh conditions. FIG. 11a shows the membrane stability under humid feed atmosphere. FIG. 11b shows the Membrane stability under H₂S containing atmosphere. FIG. 11c shows the Membrane stability under hydrocarbon containing atmosphere. The permeance under water or H₂S decreases because the MOFs show great affinity to water and H₂S, which blocks the pore systems. However, after the feed gas switching back to normal feed, the performance is fully recovered, indicating the excellent stability under humid atmosphere.

FIG. 12 shows the N₂/CH₄ separation performance of Zr-fum₆₇-mes₃₃-fcu-MOF membranes with different N₂ concentrations as feed gas. A N₂/CH₄ mixture with targeted N₂ concentration at a total flow rate of 2000 mL min⁻¹ was used on the feed side. The feed side was kept at 10 bar and the permeate side was kept at 1 bar undiluted (i.e., no sweep gas) permeate. The test was conducted at room temperature. Both the N₂ permeance and N₂/CH₄ separation factor increase with lower N₂ concentrations in the feed, which is totally different with the conventional zeolite membranes that showed decreased N₂ permeance and N₂/CH₄ separation factor under low N₂ concentrations in the feed.

FIGS. 13(A-F) show the Techno-economic comparison of distillation system with membrane or hybrid membrane-distillation system. FIGS. 13(A-C) show the Energy and utility consumption for both systems for the following feed compositions: 50% N₂/50% CH₄ (FIG. 13A), 15% N₂/85% CH₄ (FIG. 13B), and 35% CO₂/15% N₂/50% CH₄ (FIG. 13B). FIGS. 13(D-F) show the Evaluation of purification cost per MMBtu of methane for both systems for the following feed compositions: 50% N₂/50% CH₄(FIG. 13D), 15% N₂/85% CH₄ (FIG. 13E), and 35% CO₂/15% N₂/50% CH₄(FIG. 13F). (MMBtu: Metric Million British thermal unit).

### DETAILED DESCRIPTION

Natural gas contributes to at least a quarter of the global energy supply, and this proportion is expected to exceed that of coal by ˜2032. This growth presents challenges to conventional technologies for natural gas purification, because natural gas reservoirs are contaminated with N₂ and CO₂.

In contrast to the diverse routes for CO₂ capture, e.g., liquid-based absorbers, solid-state adsorbents and membranes; for N₂ removal at the plant scale, cryogenic distillation is currently the only available technology. N₂-selective membranes or CH₄-selective membranes can discriminate N₂ from CH₄, yet N₂-selective membranes are preferred because CH₄ could be rejected to the retentate at high pressures, saving the significant cost of recompression. However, due to the minor size difference, ideal N₂/CH₄ selectivities, even for state-of-the-art polymeric membranes, remain below 3. Zeolite membranes with narrow pore-apertures (˜3.8 Å), e.g. SSZ-139, SAPO-3410, AlPO-1811, and ETS-412, could perform better with some N₂/CH₄ selectivities above 10. This however comes at the price of low productivities due to the small pore-apertures, and a trade-off behavior between the permeance and selectivity remains.

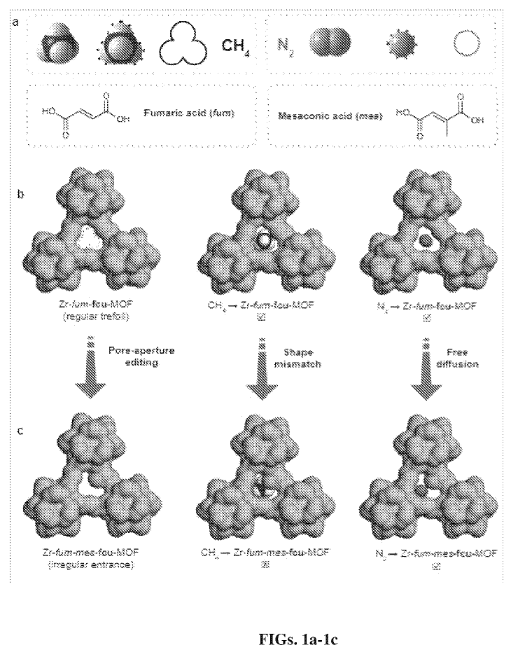

By contrast, the molecular shape disparity between N₂ and CH₄ is more significant because N₂ is linear, while CH₄ is tetrahedral (FIG. 1a). Side views of these two molecules reveal a trefoil-shaped profile for CH₄ and circular circumference for N₂ (FIG. 1a). Metal-organic frameworks (MOFs) present a highly tunable platform for structural design, allowing the precise editing of pore-aperture shape and size. Among MOFs, Zr-fum-fcu-MOF, which is assembled from a hexanuclear cluster [Zr₆O₄(OH)₄(O₂C—)₁₂] and a ditopic linker fumarate (fum) with face-centered cubic (fcu) topology, presents the desired narrow pore-apertures with the special trefoil shape (FIG. 1b). Typically, a CH₄ tetrahedron is expected to penetrate by aligning its edges parallel to the triangular entrance borders in order to precisely fit well with the trefoil-shaped pore-apertures (FIG. 1b). In principle, such a penetration of CH₄ could be blocked by altering the pore apertures so as to disrupt the original match for tetrahedral CH₄. The remaining space would be still wide enough for linear N₂ to diffuse (FIG. 1c).

The present disclosure relates to mixed linker metal organic framework (MOF) membrane compositions and the method of making the same. In particular, the embodiments of the present disclosure describe a mixed linker MOF membrane composition comprising a plurality of polynuclear metal clusters and a plurality of polydentate linkers linking one or more polynuclear metal clusters, where at least one of the polynuclear metal clusters includes a group IV metal or a rare earth metal and where the MOF has asymmetric pore aperture. Some embodiments of the present disclosure describe a mixed linker MOF membrane composition wherein the MOF has fcu topology.

In certain embodiments of the present disclosure, the mixed linker MOF membrane composition is represented by the general formula: M-L1₍₁₀₀₋ₓ₎-L2ₓ including a metal (M) and linkers L1 and L2 and where x is the molar percentage of L2 in membranes. In some embodiments of the present disclosure, the MOF is pure metal organic framework, that is, the membrane is made from MOF only and is not a composite of MOF with other materials.

Some embodiments of the present disclosure describe MOF membrane compositions where at least one linker is ditopic.

Certain embodiments of the present disclosure describe MOF compositions wherein the metal is selected from a group including, but not limited to, Ti, Zr, Hf, Ce, or from the rare earth metal La, Ce, Pr, Nd, Sm, Eu, Gd, Dy, Ho, Er, Tm, Yb, Lu, Tb or Y. Tb and Y may comprise terbium (Tb³⁺) or yttrium (Y³⁺).

Some embodiments of the present disclosure describe MOF compositions wherein the linkers may include, but are not limited to, fumaric acid, and functionalized fumaric acid. Functionalized fumaric acid may include, but is not limited to, mesaconic acid, Bromofumaric acid, Chlorofumaric acid, 2-hydroxydicarboxylic, Dihydroxyfumaric acid.

Yet other embodiments of the resent disclosure describe MOF compositions wherein the metal is Zirconium (Zr) and the linker L1 is fumarate (fum) and linker L2 is mesaconate (mes). In some embodiments of the present disclosure, the MOF composition has L1 and L2 in the ratio of 2:1. Some embodiments of the present disclosure describe MOF composition with the chemical formula Zr-fum₆₇-mes₃₃.

Embodiments of the present disclosure also describe MOF membrane comprising a support, wherein the support includes, but is not limited to, Anodisc, ceramic, polymeric, stainless steel net (SSN).

Some embodiments of the present disclosure describe MOF composition wherein the membrane has precisely edited aperture shape. Yet other embodiments of the present disclosure describe the MOF membrane wherein the aperture shape is irregular trefoil shape. Some embodiments of the present disclosure describe MOF membrane compositions with fcu topology. Yet other embodiments of the present disclosure describe MOF membrane composition wherein the linkers collocate in exactly one triangular window of the trefoil shape.

Some embodiments of the present disclosure describe MOF membrane composition, wherein the composition exhibits high throughput nitrogen removal from natural gas. Certain embodiments of the present disclosure describe MOF membrane composition wherein the composition exhibits N₂/CH₄ selectivity. Yet other embodiments of the present disclosure describe MOF membrane composition, wherein the N₂/CH₄ selectivity is greater than 15.

Embodiments of the present disclosure also describe MOF composition wherein the composition exhibits gas pair separation, wherein the gas pair is selected from the group including, but not limited to, N₂/CH₄, H₂/N₂, H₂/CH₄, CO₂/N₂, CO₂/CH₄.

Certain embodiments of the present disclosure describe MOF composition, wherein the composition exhibits simultaneous removal of CO₂ and N₂ from natural gas.

Yet other embodiments of the present disclosure describe MOF membrane composition, wherein the composition exhibits nitrogen permeance under high pressure of 30 bar-60 bar. Some embodiments of the present disclosure describe MOF membrane composition, wherein the nitrogen permeance is greater than 3000 GPU (gas permeation unit). Certain embodiments of the present disclosure describe MOF membrane compositions which exhibit separation of chemical species from a mixture of gases containing at least two chemical species. The chemical species in the mixture of gases may comprise, but is not limited to, N₂, CO₂, H₂, H₂S, CH₄, hydrocarbons, natural gas liquids, water vapor.

The embodiments of the present disclosure further describe MOF membrane composition, wherein the membrane has a thickness of 28 nm-100 nm. Certain embodiments of the present disclosure further describe MOF membrane composition, wherein the membrane has a thickness of 30 nm-50 nm. Yet other embodiments of the present disclosure describe MOF membrane composition, wherein the membrane has a thickness of 30 nm.

Method of Preparation of Mixed Linker MOF Membrane Composition with Asymmetric Pore Aperture

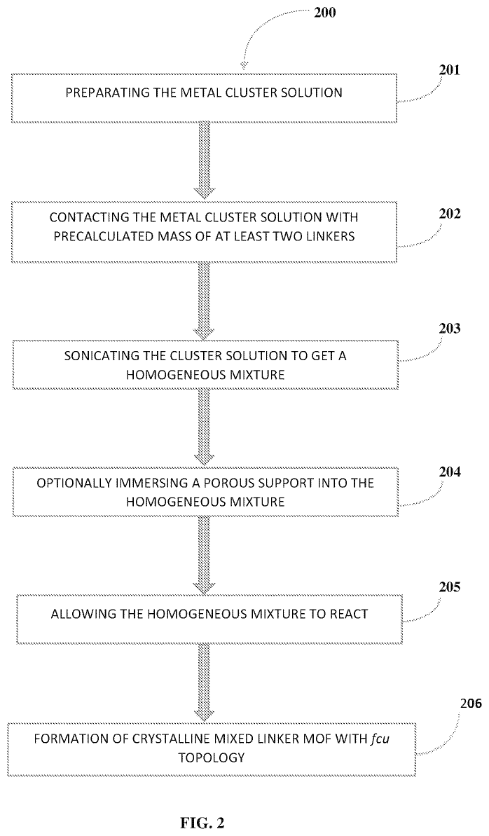

FIG. 2 is a flowchart illustrating the steps utilized in a method for preparation of mixed linker MOF membrane composition with asymmetric pore aperture, according to one or more embodiments of the present disclosure. As shown in FIG. 2, the method may comprise preparing (201) a metal cluster solution and contacting (202) the metal cluster solution with precalculated mass of at least two different linkers. The method further comprises sonicating (203) the above cluster solution sufficient to form a homogeneous mixture. The method may optionally comprise immersing (204) a support into the homogeneous mixture and applying current (205) to the mixture to form (206) a crystalline metal organic framework membrane with asymmetric pore aperture.

The step 201 includes preparation of metal cluster solution. For the preparation of [Zr₆O₄(OH)₄(O₂C—)₁₂] cluster solution, first, 0.24 g ZrCl₄ was mixed with 2.7 mL of formic acid and then ultrapure water was added to 20 mL to get a clear aqueous solution. The solution was left undisturbed at room temperature for 12 hours. The materials used were Zirconium chloride (ZrCl₄, >99.99%, Sigma-Aldrich), formic acid (98%-100%, Sigma-Aldrich). The metal cluster may comprise a group IV metal cluster or rare earth metal cluster. The metal cluster may comprise metal selected from a group including, but not limited to, Ti, Zr, Hf, Ce, or from the rare earth metal La, Ce, Pr, Nd, Sm, Eu, Gd, Dy, Ho, Er, Tm, Yb, Lu, Tb or Y. Tb and Y may comprise terbium (Tb³⁺) or yttrium (Y³⁺). The metal clusters may comprise a plurality of polydentate metal clusters.

The step 202 includes contacting the metal cluster solution with precalculated mass of at least two different linkers. For this step, fumaric acid and mesaconic acid with pre-calculated mass were added to the above cluster solution. The materials used were fumaric acid (>99%, Sigma-Aldrich), mesaconic acid (>99%, Sigma-Aldrich). The exact amount of ligands for each Zr-fum₍₁₀₀₋ₓ₎mesₓ-fcu-MOF membrane is as follows: Zr-fum₁₀₀-mes₀-fcu-MOF membrane, fumaric acid 116 mg (1 mmol); Zr-fum₇₉-mes₂₁-fcu-MOF membrane, fumaric acid 92.7 mg (0.8 mmol), mesaconic acid 56.8 mg (0.44 mmol); Zr-fum₆₇-mes₃₃-fcu-MOF membrane, fumaric acid 77.6 mg (0.67 mmol), mesaconic acid 93.7 mg (0.72 mmol); Zr-fum₆₀-mes₄₀-fcu-MOF membrane, fumaric acid 69.5 mg (0.6 mmol), mesaconic acid 113.6 mg (0.87 mmol); Zr-fum₄₁-mes₅₉-fcu-MOF membrane, fumaric acid 46.3 mg (0.4 mmol), mesaconic acid 170.4 mg (1.31 mmol). Different linkers may comprise but are not limited to, fumaric acid, and functionalized fumaric acid. Functionalized fumaric acid may include, but is not limited to, mesaconic acid, Bromofumaric acid, Chlorofumaric acid, 2-hydroxydicarboxylic, Dihydroxyfumaric acid. Different linkers may comprise polydentate linkers. Some embodiments of the present disclosure describe a method of preparation of MOF membrane wherein at least one linker is ditopic.

The step 203 includes sonicating the cluster solution obtained in 202 sufficient to form a homogeneous mixture. The sonication was performed for 2 minutes to get a homogeneous mixture. The sonication may be performed from 1 minute to 5 minutes in certain embodiments of the present disclosure.

The optional step 204 comprises immersing a support into the homogeneous mixture. The porous support with conductive Pt coatings was immersed into the sonicated homogeneous mixture obtained in step 203. Two supports with surface pore size<20 nm were used in this study. Supports may include, but are not limited to, Anodisc, ceramic, polymeric and carbon nanotubes modified stainless steel nets. Both supports were covered with an aluminum ring to make handling easy.

The step 205 includes applying current to the mixture. For this, the porous support with conductive Pt coatings immersed into the sonicated homogeneous mixture in step 204 were connected with the working electrode of the potentiostat (as cathode). A current density of 0.05 mA/cm² was applied for 2 hours (h) at room temperature. The reaction was carried out at different current densities ranging from 0.025 mA/cm² to 0.075 mA/cm². The optimum condition of current density was obtained at 0.05 mA/cm². The reaction was carried out at different time ranges in order to obtain the optimum reaction conditions. The range of time used was from 30 minutes to 4.5 hours. The optimum condition was obtained at 2 hours. Different temperature ranges were used ranging from 5° C. below room temperature to 10° C. above the room temperature. The optimum condition was obtained at room temperature.

In step 206, a crystalline metal organic framework membrane with asymmetric pore aperture was formed. The as-synthesized membranes were taken out and rinsed slowly with fresh water and water/methanol solvent for 2 min, respectively. The MOF membrane may comprise, but is not limited to, fcu topology. The mixed linker MOF membrane composition formed may be represented by the general formula: M-L1₍₁₀₀₋ₓ₎-L2ₓ including a metal (M) and linkers L1 and L2 and where x is the molar percentage of L2 in membranes. The mixed linker MOF membrane thus formed comprises precisely edited pore aperture shape. The pore aperture shape of the mixed linker MOF membrane formed by the method above may comprise, but is not limited to, irregular trefoil shape. The linkers of the MOF membrane composition thus formed may collocate in exactly one triangular window of the trefoil shape.

In certain MOF membrane composition formed by the method above, the composition exhibits high throughput nitrogen removal from natural gas. Some MOF membrane compositions thus formed exhibit N₂/CH₄ selectivity. Yet other MOF membrane compositions formed exhibit an N₂/CH₄ selectivity that is greater than 15. Certain MOF compositions exhibit gas pair separation, wherein the gas pair may comprise, but is not limited to, N₂/CH₄, H₂/N₂, H₂/CH₄, CO₂/N₂, CO₂/CH₄. Certain MOF membrane compositions formed by the method exhibit separation of chemical species from a mixture of gases containing at two chemical species. The chemical species in the mixture of gases may comprise, but is not limited to, N₂, CO₂, H₂, H₂S, CH₄, hydrocarbons, natural gas liquids, water vapor.

Certain MOF compositions thus formed, exhibit simultaneous removal of CO₂ and N₂ from natural gas. Yet other MOF membrane composition may exhibit nitrogen permeance under high pressure of 30 bar-60 bar. Some MOF membrane compositions formed may exhibit a nitrogen permeance that is greater than 3000 GPU (gas permeation unit).

The MOF membrane compositions thus formed have a thickness of 28 nm-100 nm. Certain other MOF membrane composition may have a thickness of 30 nm-50 nm. Yet other MOF membrane compositions may exhibit a membrane which have a thickness of 30 nm.

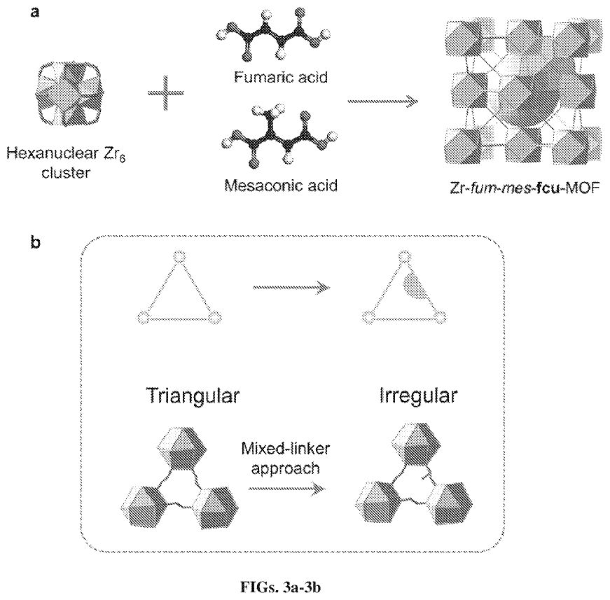

The embodiments of the present disclosure demonstrate the precise aperture editing of parent defect-free Zr-fum-fcu-MOF membranes using a mixed-linker strategy based on a facile and green electrochemical synthesis in the aqueous media and at ambient conditions. In this approach, the shape irregularity is induced by partially substituting the fumarate edge of the triangular windows with 2-methylfumarate, namely mesaconate (mes) encompassing protruding methyl groups (FIG. 3a and FIG. 3b). The experiments reveal that the optimal molar ratio of fum to mes is 2:1 for N₂/CH₄ separation, corresponding to two fumarate and one mesaconate collocated inside one triangular window. The resultant Zr-fum₆₇-mes₃₃-fcu-MOF membranes exhibit an average N₂ permeance of >3000 GPU (GPU: gas permeation unit, 1 GPU=3.35×10⁻¹⁰ mol m⁻² s⁻¹ Pa⁻¹) and a N₂/CH₄ mixture selectivity of >15 under practical conditions, both of which are among the highest reported and together represent a new standard for energy-efficient N₂ removal, saving the natural gas purification costs by 66% for a 15% N₂/85% CH₄ mixture.

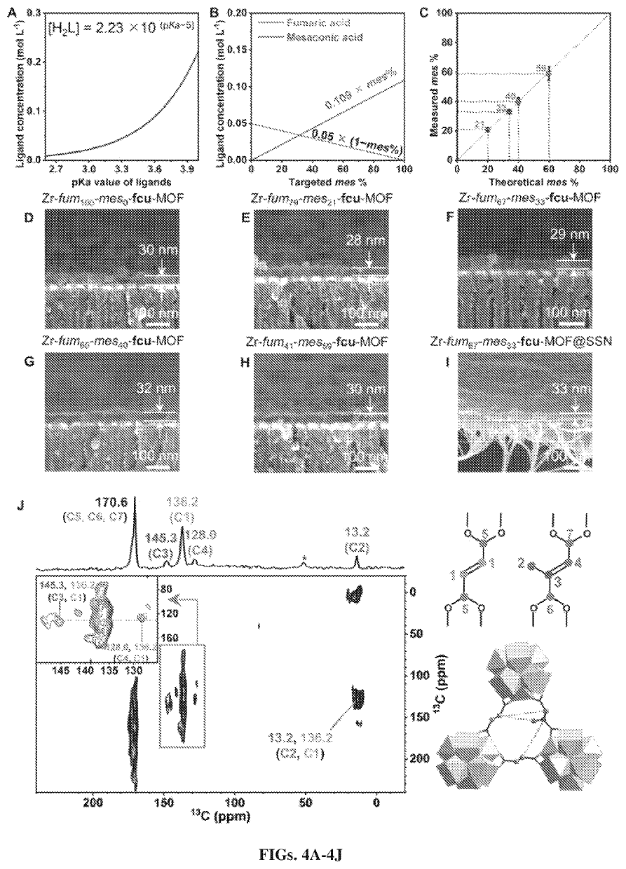

For scalability and cost reduction in membrane fabrication, the present disclosure describes the facile and green synthesis of mixed-linker Zr-fum-mes-fcu-MOF membranes with precisely controlled linker ratios and thus pore aperture editing from aqueous solutions at ambient conditions using an electrochemical approach. Conventionally, N,N-dimethylformamide (DMF) is widely adapted as the solvent for MOF synthesis owing to both its good solubility to precursors and its special role as a base to deprotonate the ligands or linkers (ligands and linkers are interchangeably used in the present disclosure). When electrochemical synthesis is applied, ligand deprotonation is largely promoted by the external current instead of by the base equivalent, implying the potential to replace DMF with a greener solvent such as water. The optimal conditions were explored for the current-driven assembly of pure fumarate Zr-fum-fcu-MOF membranes from aqueous solutions, and a defect-free layer of only 30 nm thickness was obtained after 2 hours of electrochemical synthesis at room temperature with a current density of 0.05 mA cm-2, using a preformed [Zr₆O₄(OH)₄(O₂C—)₁₂] cluster concentration of ˜8.5 mM and a fumaric acid concentration of ˜50 mM. This resulted in the achievement of an ideal concentration of the deprotonated ligand ([L²⁻]_{ideal}) during the reaction, which is critical to the formation of the continuous MOF layer. Accordingly, the predetermined parameter set permits us to derive the mathematical correlation that links the required ligand concentration ([H₂L]) with its pKa to guide the fabrication of other fcu-MOF-based membranes (FIG. 4A): [H₂L]_{Zr-fcu-MOF, a.q.}=2.23×10^{(pKa-5)}. Accordingly, for the construction of mixed-linker Zr-fum₍₁₀₀₋ₓ₎-mesₓ-fcu-MOF membranes (where x is the molar percentage of mes in the membrane), two prerequisites should be considered. First, the basic principle still requires the maintenance of a total concentration of [L2-]_{ideal} for the deprotonated ligands to guarantee layer integrity. Second, the incorporated ligand percentage is correlated with the proportion of deprotonated ligands during the reaction and sequentially depends on the concentration of pristine ligands. Hence, for a targeted Zr-fum₍₁₀₀₋ₓ₎-mesₓ-fcu-MOF membrane, the input concentration of each ligand can be calculated based on its targeted molar percentage, namely [H₂fum]_{mixed}=(100−x) %×0.05, [H₂mes]_{mixed}=x %×0.109 (FIG. 4B).

As a proof of concept, four different mes percentages were targeted, namely 20%, 33%, 40%, and 60%, and accordingly the corresponding membranes were prepared based on the guidelines prescribed above. As determined by the ¹H nuclear magnetic resonance (NMR) of acid-digested samples, the targeted ratios of the linker are in excellent agreement with experimental mes percentages: 21%, 33%, 40% and 59% (FIG. 4C). All the targeted membranes were fabricated on an Anodisc support and show well-intergrown layers, similar crystal morphology, and ultrathin thickness of ˜30 nm, which is equal to only ˜17 unit cells (FIGS. 4D-4H). Such a thin layer is among the thinnest reported and guarantees a high permeation flux. The phase purity, confirmed by X-ray diffraction (XRD), matched extremely well with the parent fcu-MOF structures. In addition, as a proof of concept to reduce membrane cost, we demonstrated the same synthesis of Zr-fum₆₇-mes₃₃-fcu-MOF membranes on an inexpensive support of a stainless steel net (SSN) modified by carbon nanotubes. This membrane exhibited a similar layer thickness and intactness (FIG. 4I).

The ligand distribution in the resulting mixed-linker structure is critical for realizing targeted pore-aperture-editing, because as a prerequisite the fumarate and mesaconate linkers are required to all collocate in exactly one triangular window so as to transform the trefoil-shaped aperture into an irregular entrance. To precisely confirm such an aperture editing, two-dimensional (2D) magic-angle spinning (MAS) solid-state NMR (ssNMR) measurements were applied to the Zr-fum₆₇-mes₃₃-fcu-MOF, because the atoms from the two linkers were expected to provide correlation signals when they are collocated within a single window. The application of 2D ¹H⁻¹H double-quantum (DQ)/single-quantum (SQ) ssNMR to detect proton correlations was not conclusive, because the peaks of protons connected to the C═C bonds from fumarate and mesaconate were merged at 6.9 ppm owing to the relatively low resolution of ssNMR. By contrast, one-dimensional (1D) ¹³C spectra revealed that the C atoms from the two linkers could be clearly distinguished under ssNMR (FIG. 4J). Accordingly, the 2D ¹³C-¹³C correlation spectra (FIG. 4J) was acquired using proton-driven spin diffusion (PDSD) by phase-alternated recoupling irradiation schemes (PARIS). The correlation between the 13.2 and 136.2 ppm peaks can be clearly observed; these peaks originate from the carbon atom of the methyl group in mesaconate and the double-bond carbon atoms in fumarate, respectively (FIG. 4J). The strong correlation indicates that the two linkers are in close physical proximity, that is, they are collocated within one window. Moreover, the double-bond carbon atoms from both linkers also gave detectable correlations at (128.0 ppm, 136.2 ppm) and (145.3 ppm, 136.2 ppm), again indicating that pore-aperture-editing was indeed realized (FIG. 4J). Furthermore, because the molar ratio of fum/mes for Zr-fum₆₇-mes₃₃-fcu-MOF membranes was 2:1, it is clear that the obtained triangular windows were precisely edited to be circumscribed by one mesaconate and two fumarate edges (FIG. 4J). The triangular window of fcu-MOFs, which is the sole entrance to the pore system for guest molecules and determines the ultimate molecular sieving capability, can be precisely tuned by rationally altering metal clusters as well as organic linkers embedding reasonable length and bulkiness. Principally, ligand length change or functionalization permits ultra-tuning of the window size in angstrom or sub-angstrom scale, respectively, while metal cluster replacement affords unparalleled control of the pore aperture at the level of 0.1-0.2 Å.

Method of Separation of Chemical Species from a Mixture of Gases

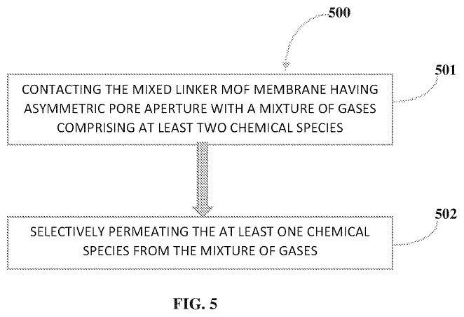

FIG. 5 is a flowchart illustrating the steps utilized in a method for separating chemical species from a mixture of gases, according to one or more embodiments of the present disclosure. As shown in FIG. 5, the method may comprise contacting (501) the mixed linker MOF membrane having asymmetric pore aperture with a mixture of gases comprising at least two chemical species. This is followed by selectively permeating (502) the at least one chemical species through the MOF membrane, thereby separating the chemical species from the mixture.

The step 501 includes contacting the mixed linker MOF membrane having asymmetric pore aperture with a mixture of gases comprising at least two chemical species. In this step, one or more chemical species of the mixture of gases are brought into physical contact with the MOF membrane, wherein the membrane includes mixed linker MOF membrane with asymmetric pore aperture. The contacting may include one or more of feeding, flowing, passing, injecting, introducing, and providing, among other things. For example, the mixture of gases may be fed (e.g., as a feed stream) to the MOF membrane sufficient to make contact with the membrane. The contacting may proceed at and/or under any suitable reaction conditions. For example, the temperature, pressure, concentration of chemical species in the mixture of gases, and flow rates, among other parameters, may be selected and/or adjusted according to a specific application.

The mixture of gases may be provided in any phase or combination of phases. For example, if the mixture of gases is natural gas, it may contain one or more of a liquid, vapor, and gas. The mixture of gases may include two or more chemical species, such as two or more, three or more, or four or more chemical species. The chemical species of the mixture may include one or more of O₂, N₂, H₂, He, CO₂, H₂S, C₁+ hydrocarbons (e.g., CH₄), olefins, paraffins, n-butane, iso-butane, butenes, and xylene isomers. In many embodiments, the chemical species of the mixture may include at least two or more of the following pairs of chemical species: O₂ and N₂, H₂ and N₂, N₂ and CO₂, H₂ and CH₄, N₂ and CH₄, H₂ and C₁, hydrocarbons, He and C₁, hydrocarbons, CO₂ and C₁, hydrocarbons (CO₂/CH₄), CO₂ and N₂, H₂S and C₁₊ hydrocarbons, olefins and paraffins, n-butane and iso-butane, n-butane and butenes, xylene isomers, and combinations thereof. In other embodiments, the chemical species of the mixture of gases may include any combination of two or more of the chemical species described herein.

The step 502 includes selectively permeating the at least one chemical species through the MOF membrane, thereby separating the chemical species from the mixture. In this step, at least one of the chemical species present in the mixture is separated from one or more of the other chemical species present in the mixture. The separating may depend on a number of factors, including, but not limited to, selectivity, diffusivity, permeability, solubility, conditions (e.g., temperature, pressure, and concentration), membrane properties (e.g., pore size, pore aperture shape), and the methods used to fabricate the membranes. In many embodiments, the separating may be based on, among other things, permeability, such as differences in permeability of one or more chemical species, among other types of separations. For example, the separating may be achieved by selectively permeating one or more chemical species through the membrane while retaining the other chemical species. In other embodiments, the separation may be based on one or more of permeability of the mixed linker MOF membrane based on the pore aperture shape which functions as a molecular sieve. The irregular trefoil shape of the pore aperture may block some molecules (e.g. Methane) to pass through thus effectively separating the methane from other gaseous or liquid impurities or contaminants. Thus, precisely editing the pore aperture shape of mixed linker MOFs leads to efficient purification of natural gas.

### EXAMPLES

### Example 1: Synthesis of Zr-Fum₆₇-Mes₃₃-Fcu-MOF Membrane

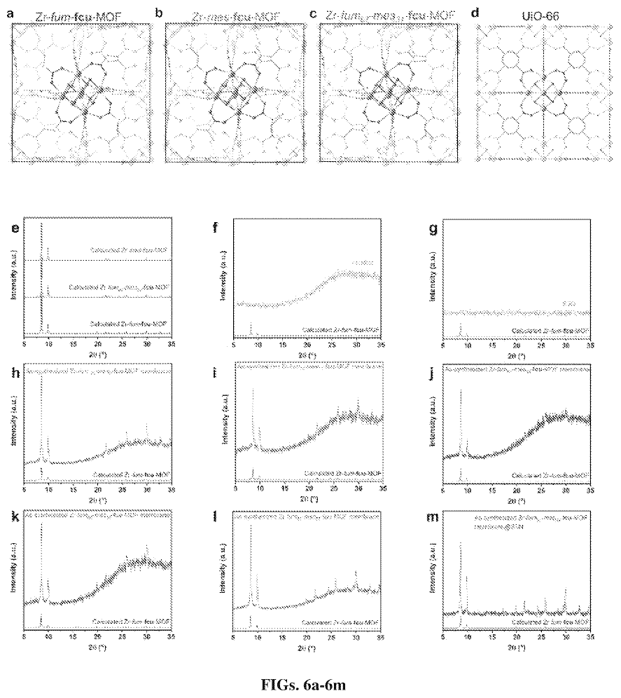

For the synthesis of Zr-fum₆₇-mes₃₃-fcu-MOF membrane, the starting metal cluster used was [Zr₆O₄(OH)₄(O₂C—)₁₂]. For the preparation of [Zr₆O₄(OH)₄(O₂C—)₁₂] cluster solution: 0.24 g ZrCl₄ was mixed with 2.7 mL of formic acid and then ultrapure water was added to 20 mL to get a clear aqueous solution. The solution was left undisturbed at room temperature for 12 hours. This was followed by preparation of Zr-fum₆₇mes₃₃-fcu-MOF membranes by current-driven assembly. First, fumaric acid and mesaconic acid with pre-calculated mass were added to the above cluster solution and sonicated for 2 min to get a homogeneous solution. The exact amount of ligands precalculated for Zr-fum₆₇-mes₃₃-fcu-MOF membrane is: fumaric acid 77.6 mg (0.67 mmol), mesaconic acid 93.7 mg (0.72 mmol). The porous support with conductive Pt coatings was immersed into the resulting sonicated homogenous solution and connected with the working electrode of the potentiostat (as cathode). Two supports with surface pore size<20 nm were used in this study, Anodisc and carbon nanotubes modified stainless steel nets. Both supports were covered with an aluminum ring to make the handling easy. A current density of 0.05 mA/cm2 was applied for 2 h at room temperature, after which the as-synthesized membrane was taken out and rinsed slowly with fresh water and water/methanol solvent for 2 min, respectively. The Zr-fum₆₇mes₃₃-fcu-MOF membrane formed was characterized using XRD pattern. FIG. 6(a-m) show the structures and XRD patterns of Zr-fum-mes-fcu MOF membranes.

### Example 2: Practical Evaluation of N₂ Removal and Natural Gas Purification

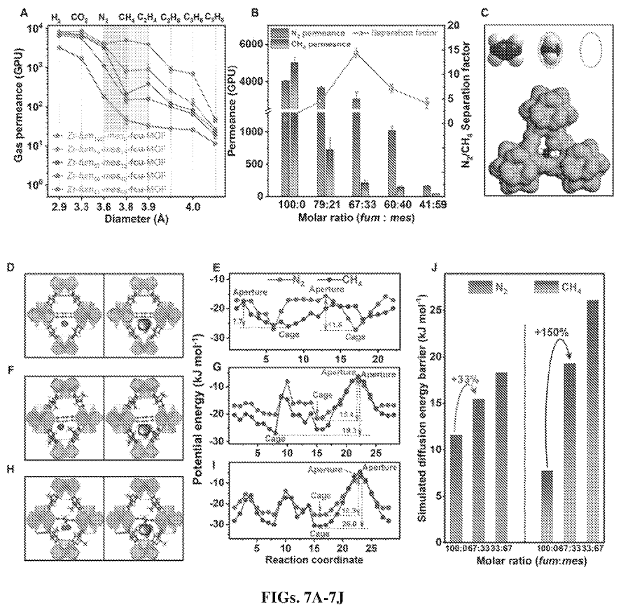

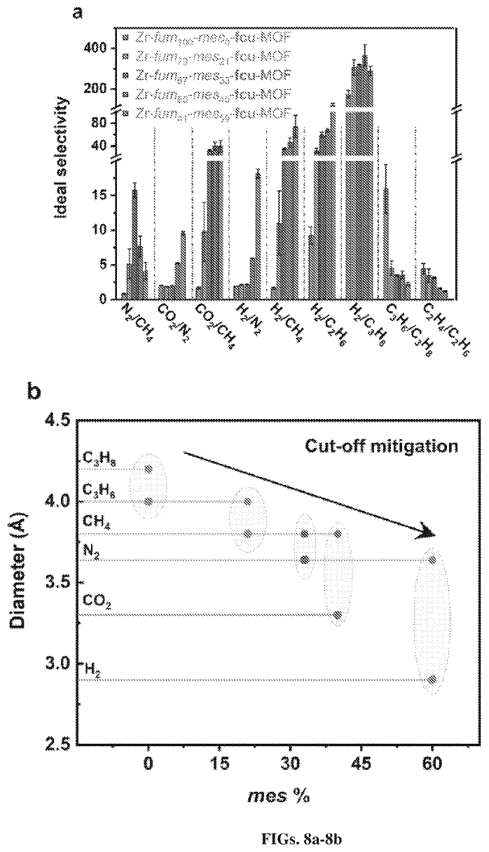

Single-gas permeation of membranes with different mes loadings were measured. All gas permeances decreased as the mes loading increased, owing to the associated narrowed pore-aperture sizes and, thus, increased transport resistance (FIG. 7A). Notably, the permeance cut-off gradually moved towards smaller gas pairs, for example, moving from C₃H₆/C₃H₈ to N₂/CH₄, then to CO₂/CH₄ and H₂/N₂, as revealed by changes in ideal selectivities (FIG. 8a and FIG. 8b). FIG. 8a shows the Ideal selectivities of different Zr-fum-mes-fcu-MOF membranes for different gas pairs. FIG. 8b shows the cut-off mitigation among different Zr-fum-mes-fcu-MOF membranes as a function of mes percentage.

Subsequently, all five different membranes were further evaluated for N₂/CH₄ mixed-gas separation, among which Zr-fum₆₇-mes₃₃-fcu-MOF membranes with fum/mes ratios of 2:1 offered the highest N₂/CH₄ separation factor of 15 and an average N₂ permeance of 3057 GPU on average (FIG. 7B). For the parent Zr-fum₁₀₀-mes₀-fcu-MOF membranes, both N₂ and CH₄ could freely permeate, showing selectivities close to those generated by Knudsen diffusion. Steadily increasing the replacement of fumarate with mesaconate led to a dramatic decrease in CH₄ permeance but a slight decrease in N₂ permeance when mes %≤33%, thus enhancing the N₂/CH₄ separation factor (FIG. 7B). The enhanced separation capability is mainly attributed to the as-designed irregularity of the pore aperture and its mismatch with the CH₄ tetrahedron rather than size exclusion. Affirmatively, ethylene (C₂H₄) molecules with a larger kinetic diameter than that of CH₄ but with a pseudo-linear shape showed higher permeance than CH₄ for Zr-fum₆₇-mes₃₃-fcu-MOF membrane (FIG. 7A). The separation driven by size difference would favor the diffusion of smaller CH₄ molecules, whereas configuration mismatch favors the diffusion of pseudo-linear C₂H₄(FIG. 7C). However, further increase in mes %, for example, beyond 33%, did not lead to higher selectivity; instead, selectivity decreased. Apparently, when the fum/mes ratio is higher than 2:1, more than one mesaconate might be present in some of the triangular windows, leading to significant narrowing of pore apertures and thus a severe decrease in N₂ permeance (FIG. 7B). Consequently, a Zr-fum₆₇-mes₃₃-fcu-MOF membrane composition represents a sweet spot that optimally performs the mismatch-induced separation with both high permeance and high selectivity.

Molecular simulations showed, after replacing one fumarate by mesaconate in the triangular window, that the diffusion energy barrier for CH₄ increased by more than 150%, whereas that for N₂ increased by only 33%, leading to enhanced N₂/CH₄ selectivity (FIG. 7D-FIG. 7J). Molecular insight into the separation process was further revealed by periodic density functional theory (DFT) calculations. The minimum energy path (MEP) associated with the N₂ and CH₄ transport via a jump sequence from cage to cage by passing the edited apertures was simulated for the different Zr-fum₍₁₀₀₋ₓ₎mesₓ-fcu-MOFs using DFT climbing image nudged elastic band (CI-NEB) method. The selected diffusion path corresponds to a length of ˜25 Å, integrating the passage between multiple neighbor cages connected by pore apertures. The calculated MEP profiles showed that both N₂ and CH₄ molecules could migrate through the trefoil-shaped apertures of the parent Zr-fum₁₀₀-mes₀-fcu-MOF (FIG. 7D) with rather low energy barriers, i.e., 11.5 and 7.7 kJ mol-1, respectively, that suggest a fast transport for both gases throughout this MOF (FIG. 7E). The slightly higher diffusion energy barrier for N₂ vs CH₄ is in line with the experimental findings that CH₄ shows higher permeance in the parent Zr-fum₁₀₀-mes₀-fcu-MOF membrane. For the Zr-fum₆₇-mes₃₃-fcu-MOF (FIG. 7F), the diffusion energy barrier for CH₄ increased by more than 150% (from 7.7 to 19.3 kJ mol-1), whereas that for N₂ increased by only 33% (from 11.5 to 15.4 kJ mol-1 FIGS. 3G and 3J). This disparity explains the substantial permeance reduction for CH₄ and the considerably smaller decrease for N₂, thus generating a significant enhancement in N₂/CH₄ selectivity. Beyond this optimum, the simulated diffusion energy barriers for both continued to increase to rather high values, as exemplified in the case of Zr-fum₃₃-mes₆₇-fcu-MOF (FIG. 7H-FIG. 7J). These high values resulted in significant reduction in gas permeance and selectivity. These molecular insights pinpoint to the uniqueness of the shape-mismatch-induced separation of N₂ and CH₄, where selectivity can be considerably improved without significant loss in permeance, in sharp contrast to the conventional size-exclusion-based separation.

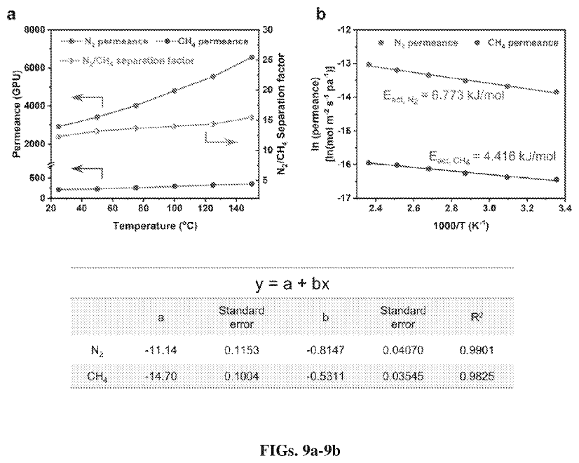

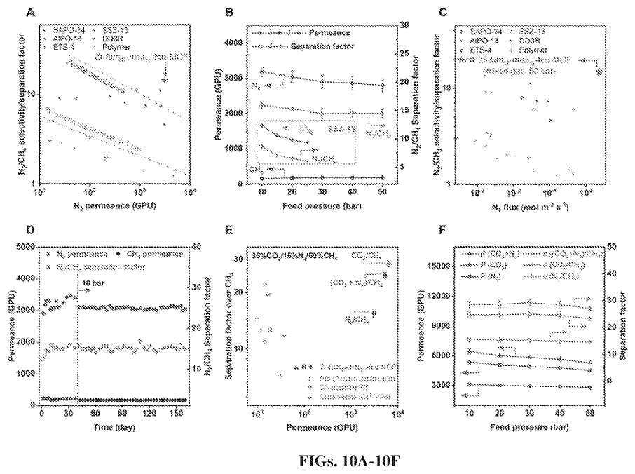

Notably, beside its outstanding separation performance, the Zr-fum₆₇-mes₃₃-fcu-MOF membranes offer excellent thermal stability as well. Both the N₂ permeance and the N₂/CH₄ separation factor increased at elevated temperatures. Moreover, fitting the gas permeance of Zr-fum₆₇-mes₃₃-fcu-MOF membranes at different temperatures to the Arrhenius equation shows that the apparent activation energies for the N₂ and CH₄ permeation are 6.8 and 4.4 kJ mol-1, respectively (FIG. 9a-b). Zr-fum₆₇-mes₃₃-fcu-MOF membranes show superior performance compared with other membranes, for both N₂ permeance and N₂/CH₄ selectivity, surpassing the upper bounds for polymeric and zeolite membranes (FIG. 10A). The mixed linker MOF membranes of the present disclosure are capable of separating the N₂/CH₄ mixture, and the rich design ability of the MOF platform brings additional potential and creates a new threshold for unlocking difficult separations that cannot be resolved well by other methods.

For the practical evaluation of the mixed linker membranes with asymmetric pore aperture of the present disclosure, N₂/CH₄ separation performance under high pressures is typically a necessary parameter to disclose because industrial processing usually operates at 30-60 bar. For reported zeolite membranes, such as state-of-the-art SSZ-13 membranes, high feed pressure leads to severe selectivity loss and the N₂/CH₄ separation factor decreases to only ˜6 for a 25 bar feed (FIG. 10B). By contrast, when the feed pressure is elevated to 50 bar and the permeate side is maintained at 1 bar without sweep gas, Zr-fum₆₇-mes₃₃-fcu-MOF membranes show only slightly (˜−8%) reduced N₂ permeance (FIG. 10B), mainly owing to the nonlinear adsorption behavior that commonly happens to nanoporous membranes. Accordingly, the N₂/CH₄ separation factor is reduced only slightly (˜−3%) and the overall performance does not deviate much from that at low feed pressures (FIG. 10B).

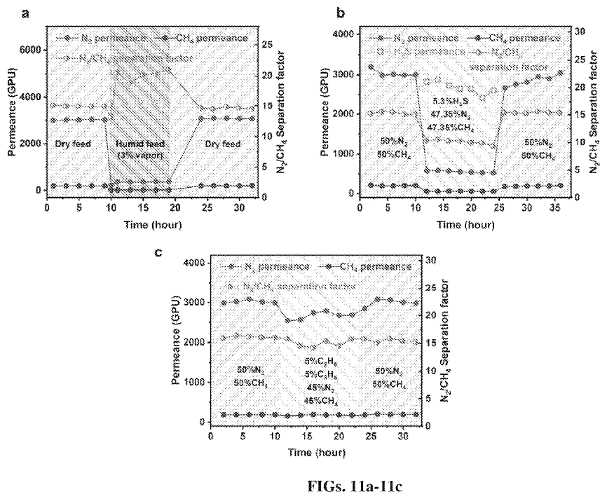

The MOF membranes of the present disclosure were compared with state-of-the-art reported membranes in terms of the absolute N₂ flux and N₂/CH₄ separation factor. Zr-fum₆₇-mes₃₃-fcu-MOF membranes exhibit an N₂ flux more than two orders of magnitude greater than those of other membranes with decent selectivity (i.e., approximately 10) (FIG. 10C). This indicates the uniqueness of the shape-mismatch-induced separation mechanism. In addition, the Zr-fum₆₇-mes₃₃-fcu-MOF membranes suggest exceptional robustness, because separation performance does not degrade after continuous permeation for 150 days (FIG. 10D). We further mimicked the complex feed streams with trace amounts of other impurities, such as water vapor, hydrocarbons, and corrosive hydrogen sulfide (FIG. 11a-c). The presence of hydrocarbons led to slight fluctuation in N₂/CH₄ separation, while water vapor and hydrogen sulfide presence resulted in decreased permeance owing to their strong affinities to the MOFs, blocking other species. However, once the feed was switched back to normal, N₂/CH₄ separation always resumed its initial benchmark values, indicating the excellent membrane stability. Along with the practical pressure-resistant capability, these qualities position Zr-fum₆₇-mes₃₃-fcu-MOF membranes as an attractive candidate for industrial-scale N₂ rejection.

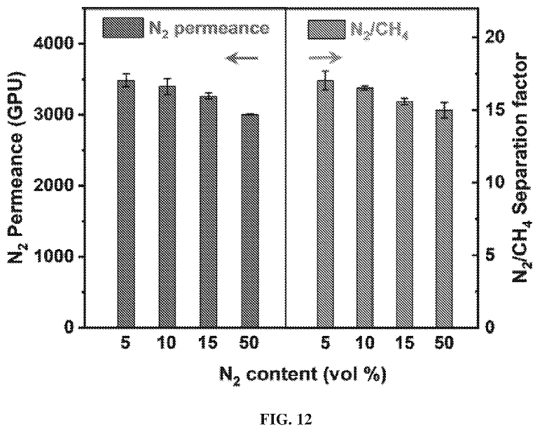

Considering the variability of N₂ concentrations across different natural gas fields, the N₂/CH₄ separation performance of Zr-fum₆₇-mes₃₃-fcu-MOF membranes was evaluated with varying N₂ concentrations from 5% to 15% in the feed stream. In contrast to the zeolite membranes, for which lower N₂ concentration cause reduced N₂ permeance and N₂/CH₄ selectivity, both N₂ permeance and N₂/CH₄ selectivity of Zr-fum₆₇-mes₃₃-fcu-MOF membranes increased at lower N₂ concentrations (FIG. 12). When 5% N₂ feed gas at a total pressure of 10 bar was applied, an average N₂ permeance of 3486 GPU and an N₂/CH₄ separation factor of 17 were obtained. The slightly enhanced permeance is attributed to the nonlinear adsorption behaviors for nanoporous membrane materials. Notably, this pressure-resistant behavior is also maintained at low N₂ feed concentrations at elevated pressures of 50 bar, as exemplified by the use of a 15% N₂/85% CH₄ feed stream.

Due to the excellent performance at low N₂ concentrations, the possibility of purifying natural gas from ternary mixtures was explored. Purifying natural gas from ternary mixture would comprise simultaneously removing CO₂ and N₂ from CH₄, given that CO₂ molecule also shows a linear configuration. When a ternary mixture containing 35% CO₂/15% N₂/50% CH₄ at 10 bar was used as the feed, the membranes of the present disclosure offered average CO₂ and N₂ permeance of 6432 and 3098 GPU, respectively, with average CO₂/CH₄ and N₂/CH₄ separation factors of 28.5 and 15.5, respectively (FIG. 10E). Taking CO₂ and N₂ together as a single contaminant with a concentration of 50% in the feed gas, an overall removal permeance of impurities (CO₂+N₂) of 5344 GPU and an impurity/CH₄ separation factor (namely α(CO₂+N₂)/CH₄) of 24.6 (FIG. 10E) could be derived. Again, the pressure-resistant capability of Zr-fum₆₇-mes₃₃-fcu-MOF membranes provided stable operation at high pressures up to 50 bar without degradation (FIG. 10F). Notably, the simultaneous removal of CO₂ and N₂ from CH₄ using membranes has scarcely been reported except for rare examples of polymers and mixed-matrix membranes, probably owing to poor N₂ removal efficiency under low N₂ concentrations for other types of membranes. Compared with the polymeric and mixed-matrix membranes previously reported, Zr-fum₆₇-mes₃₃-fcu-MOF membranes exhibit better separation selectivity and permeance higher by three orders of magnitude. These differences attest to the uniqueness and power of pore-aperture-edited MOF membranes to address the practicalities of the natural gas purification process.

In order to reduce membrane cost, the same electrochemical approach was used in the case of the aqueous solutions to prepare additional Zr-fum₆₇-mes₃₃-fcu-MOF membranes on cheap SSN supports modified by carbon nanotubes (FIG. 4I). The separation performance was thoroughly measured, including at high feed pressures up to 50 bar, at low N₂ feed concentrations, and in CH₄ purification from ternary mixtures. Evidently, the use of cheap SSN supports did not cause any loss to either the permeance or the separation factor. In addition, pore-aperture-edited MOF membranes exhibited the potential to separate other gas pairs, such as N₂/CH₄, H₂/N₂, H₂/CH₄, CO₂/N₂, and CO₂/CH₄. Through stepwise pore-aperture editing, one could transform originally less effective frameworks into highly selective ones. These membranes offer advantageous separation performance, going beyond the upper bounds reported for polymers and other MOF membranes. Furthermore, Zr-fum₆₇-mes₃₃-fcu-MOF membranes supported on cheap SSN exhibited similarly excellent separation performance, including high feed pressures up to 50 bar, at low N₂ feed concentrations, and in CH₄ purification from ternary mixtures.

### Example 3: Techno-Economic Analysis for N₂ Removal and Natural Gas Purification Using Mixed Linker MOF Membrane

To evaluate the potential energy and cost savings of the mixed linker MOF membranes of the present disclosure for nitrogen rejection in the natural gas purification process, a process simulation was performed using Aspen Plus®. As a base scenario for comparison with the membrane system, first a conventional cryogenic distillation process was modeled targeting a high CH₄ purity with 3% N₂. These cryogenic distillation columns, despite being standard in the industry, consume vast amounts of energy owing to the low temperatures required (typically below −100° C.). To maximize realism, two possible scenarios were modeled with different raw CH₄ feed purities, namely 15% N₂/85% CH₄ and 50% N₂/50% CH₄. To achieve the desired separation, the model indicates that very low temperatures are required (−148° C. and −99° C. for the condenser and reboiler, respectively), which translate to as much as 3.75 MW of energy duty for a 1000 kmol h⁻¹ feed.

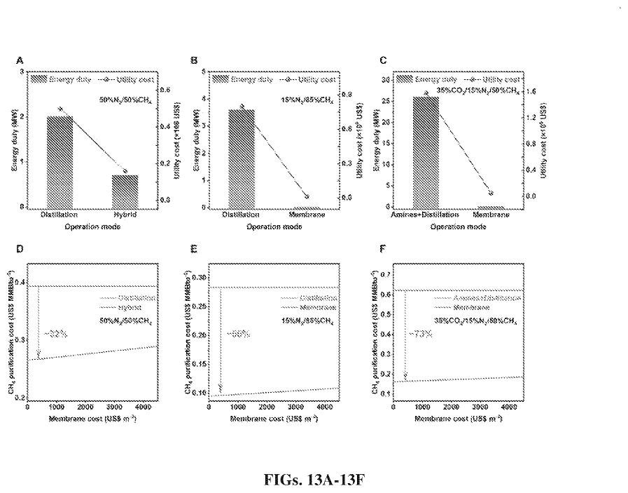

Deployment of the mixed linker MOF membrane of the present disclosure for N₂ removal yields rather different results. For the 50% N₂/50% CH₄ feed, the membrane alone cannot provide the required purity; therefore, a hybrid system is needed, where the membrane acts as a pre-separator to reduce the load on the column. The model shows that 67% of the total energy of the distillation column can be saved by using the membrane-distillation hybrid system, which translates to a 74% utility cost savings (FIG. 13A). In particular, both the steam cost and the refrigerant cost decrease dramatically when the hybrid system is used. By contrast, for the 15% N₂/85% CH₄ feed, the membrane can virtually replace the cryogenic distillation system. Moreover, because the membrane is N₂-selective and the purified CH₄ retentate is maintained at the high-pressure side, no recompression is needed; therefore, all of the energy associated with the column can be saved (FIG. 13B).

Analysis of the total purification costs of CH₄ based on cryogenic distillation vs. membrane systems was performed. Massive cost reduction was observed when the membrane was used, regardless of the membrane price or stream composition (FIG. 13D and FIG. 13E). For the 50% N₂/50% CH₄ feed, ˜66 ktonnes of CH₄ was purified, with a
32% reduction in purification cost (FIG. 13D). Meanwhile, for the 15% N₂/85% CH₄ feed,
114 ktonnes of CH₄ was purified, with a ˜66% reduction in purification cost (FIG. 13E). This cost reduction is a direct consequence of the vast energy savings of the membrane system, highlighting the advantages of the pore-aperture-edited mixed linker MOF membrane of the present disclosure compared with conventional energy-intensive cryogenic processes.

Process simulations were performed focused on CO₂ separation to evaluate the simultaneous removal of CO₂ and N₂ from natural gas using the membranes of the present disclosure in comparison with using current industrial technologies. In particular, the amine-based CO₂ capture was simulated by simulating methyl diethanolamine (MDEA) absorption of a stream composition of 35% CO₂/15% N₂/50% CH₄. This absorption process was modeled as a chemical equilibrium with an absorber and a regeneration stripper closed cycle. The purity target was 3% in order to avoid pipeline corrosion. The simulation shows that the conventional amine process requires 11.5 MW heating duty and 10.9 MW cooling duty for CO₂ removal, which translates to US$0.34 MMBtu⁻¹ (Metric Million British thermal unit) of purification cost. Combined with the costs of the N₂ rejection columns for sequential N₂ removal, the total energy duty and utility cost for the removal of CO₂ and N₂ are 26 MW and US$1.58×106, respectively (FIG. 13C). Accordingly, the CH₄ purification cost is increased to US$0.62 MMBtu⁻¹ (FIG. 13F). By contrast, for this particular stream composition (35% CO₂/15% N₂/50% CH₄), the mixed linker MOF membrane of the present disclosure can virtually replace the amine and cryogenic combination to simultaneously remove CO₂ and N₂, saving 100% of the heating and cooling duties (FIG. 13C) and delivering the required purities to reach pipeline specifications. However, for the 35% CO₂/15% N₂/50% CH₄ feed, ˜72 ktonnes of CH₄ was purified, and deployment of the pore-aperture-edited mixed linker MOF membranes reduced purification costs by ˜73%.

Above description, explanation and examples demonstrate that precise pore aperture editing of MOF membranes to introduce a spatial mismatch between the pore aperture shape and the molecular configurations of gases gives rise efficient N₂/CH₄ separation. According to some embodiments of the present disclosure, the protruding methyl group of mesaconate disrupts the parent regularity of trefoil-shaped apertures to selectively induce greater transport resistance to the CH₄ tetrahedron while only modestly affecting the permeation of the linear molecule N₂. Zr-fum₆₇-mes₃₃-fcu-MOF membranes of the present disclosure represent the compositional optimum for pore-aperture-editing and exhibit by far the best combination of N₂ permeance (>3000 GPU) and N₂/CH₄ separation factor (>15). Notably, these membranes are operable at practical high feed pressures up to 50 bar without obvious performance degradation, including feed streams of both N₂/CH₄ binary mixtures and CO₂/N₂/CH₄ ternary mixtures. Such pressure-resistant behavior, coupled with the robustness of the membranes, sets a new standard for high-throughput natural gas purification. Process analysis shows that deployment of the membranes of the present disclosure for N₂ removal enables massive energy and cost savings compared with the conventional cryogenic distillation method, generating ˜66% and ˜32% CH₄ purification cost reductions for the feeds of 15% N₂/85% CH₄ and 50% N₂/50% CH₄, respectively. For the membrane-based simultaneous removal of CO₂ and N₂ from a 35% CO₂/15% N₂/50% CH₄ ternary mixture, purification cost is reduced by ˜73% compared with the conventional amine/distillation combination. Rational design of membrane synthesis enables the facile and green fabrication of high-performance membranes at room temperature under ambient atmosphere, using water as the solvent and cheap SSNs as supports. All these factors underline the potential for future applications.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims. Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus, the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

Various examples have been described. These and other examples are within the scope of the following claims.

1. A mixed linker metal organic framework (MOF) membrane composition, the MOF composition comprising:
a plurality of polynuclear metal clusters, wherein at least one of the polynuclear metal clusters includes a group IV metal or rare earth metal; and
a plurality of polydentate linkers linking one or more polynuclear metal clusters; wherein the MOF has asymmetric pore aperture; wherein the composition is represented by the general formula:
M-L1₍₁₀₀₋ₓ₎-L2ₓ including a metal (M) and linkers L1 and L2,
wherein x is the molar percentage of L2 in membranes.

2. The composition of claim 1, wherein the MOF is pure metal organic framework.

3. The composition of claim 1, wherein at least one linker is ditopic.

4. The composition of claim 1, wherein the metal comprises Ti, Zr, Hf, Ce, La, Ce, Pr, Nd, Sm, Eu, Gd, Dy, Ho, Er, Tm, Yb, Lu, Tb or Y.

5. The composition of claim 1, wherein the linkers comprise fumaric acid and functionalized fumaric acid.

6. The composition of claim 1, wherein the functionalized fumaric acid comprises mesaconic acid, Bromofumaric acid, Chlorofumaric acid, 2-hydroxydicarboxylic, Dihydroxyfumaric acid.

7. The composition of claim 1, wherein the metal is Zirconium (Zr).

8. The composition of claim 1, wherein the linker L1 is fumarate (fum).

9. The composition of claim 1, wherein the linker L2 is mesaconate (mes).

10. The composition of claim 1, wherein the metal is Zr and L1 is fumarate and L2 is mesaconate.

11. The composition of claim 10, wherein the ratio of L1 to L2 is 2:1.

12. The composition of claim 1, wherein the MOF has the chemical formula:
Zr-fum₆₇-mes₃₃

13-28. (canceled)

29. A method of making a mixed linker metal organic framework (MOF) membrane comprising:
preparing a metal cluster solution;
contacting the metal cluster solution with precalculated mass of at least two different linkers;
sonicating the cluster solution sufficient to form a homogeneous mixture;
optionally immersing a support into the homogeneous mixture;
applying current to the mixture sufficient to form a crystalline metal organic framework membrane with asymmetric pore aperture.

30-56. (canceled)

57. A method for separating chemical species from a mixture of gases comprising:
contacting the mixed linker MOF membrane having asymmetric pore aperture with a mixture of gases comprising at least two chemical species; and
selectively permeating the at least one chemical species through the MOF membrane, thereby separating the chemical species from the mixture;
wherein the mixed linker MOF membrane comprises a plurality of polynuclear metal clusters, wherein at least one of the polynuclear metal clusters includes a group IV metal or rare earth metal; and
a plurality of polydentate linkers linking one or more polynuclear metal clusters.

58. The method in claim 57, wherein the MOF membrane has the general formula:
M-L1₍₁₀₀₋ₓ₎-L2ₓ including a metal (M) and linkers L1 and L2, wherein x is the molar percentage of L2 in membranes.

59. The method of claim 57, wherein the chemical species is methane and at least one of H₂, N₂, CO₂.

60. The method of claim 57, wherein at least one linker is ditopic.

61. The method of claim 57, wherein the metal comprises Ti, Zr, Hf, Ce, La, Ce, Pr, Nd, Sm, Eu, Gd, Dy, Ho, Er, Tm, Yb, Lu, Tb or Y.

62. The method of claim 57, wherein the linkers comprise fumaric acid and functionalized fumaric acid.

63. The method of claim 62, wherein the functionalized fumaric acid comprises mesaconic acid, Bromofumaric acid, Chlorofumaric acid, 2-hydroxydicarboxylic, Dihydroxyfumaric acid.

64-86. (canceled)
